(19) United States
(12) Patent Application Publication
(10) Pub. No.: US 2006/0176263 A1
(43) Pub. Date: Aug. 10, 2006

(54) Display device and method of driving the same

(75) Inventors: Myung-Koo Kang, Seoul (KR); Lintao Zhang, Yongin-si (KR); Jung-Sun Lee, Gwangju-si (KR); Jong-Hwa Park, Seoul (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/256,449

(22) Filed: Oct. 20, 2005

(30) Foreign Application Priority Data
Feb. 7, 2005 (KR) 2005-11286

(51) Int. Cl. G09G 3/36

(52) U.S. Cl. 345/98

(57) ABSTRACT

A display device includes a data driver, an inverter, a display panel, and an intercept unit. The data driver provides an image signal and the scan driver generates a control signal corresponding to the image signal. The inverter provides an inverted control signal. The display panel has a PMOS transistor that provides the image signal to a pixel electrode based on the inverted control signal. The interception unit intercepts an abnormal signal that is forwarded to the PMOS transistor. Therefore, a signal having an abnormal voltage level may be interrupted to prevent display defects resulting from the abnormal voltage level.

### CROSS REFERENCE TO RELATED APPLICATION

This application claims priority under 35 USC § 119 to Korean Patent Application No. 2005-11286, filed on Feb. 7, 2005, the contents of which are herein incorporated by reference in their entirety for all purposes.

### BACKGROUND

1. Field of the Invention

The present invention relates to a display device and a method of driving the display device and, more particularly to a display device capable of preventing display defects of a PMOS device and a method of driving the display device.

2. Description of the Related Art

Generally, a thin film transistor (TFT) formed on a glass or a semiconductor substrate in a thin film controls a gate electrode in order to control a current flow through a semiconductor layer. The thin film transistor (TFT) is widely used for liquid crystal displays (LCD), memories such as static RAM (SRAM), etc.

The types of TFTs include amorphous silicon TFTs (a-Si TFT) and polysilicon TFTs (poly-Si TFT). The types of poly-Si TFT include high temperature polysilicon (HTPS) TFTs or low temperature polysilicon (LTPS) TFTs, depending on processing temperature.

Polysilicon (poly-Si) provides greater electron mobility and lower leakage current compared with amorphous silicon (a-Si). Such electrical characteristics of the poly-Si TFT may enable the LTPS to integrate a driver circuit for the TFT in a liquid crystal display panel. Generally, it is required for the TFT to have an electron mobility greater than 1 cm2/Vsec and a leakage current below 0.1 pA/m. An N type thin film transistor (n-TFT) or a P type thin film transistor (p-TFT) may be used to form the LTPS TFT, while only the n-TFT is used in the a-Si TFT.

FIG. 1 is an equivalent circuit diagram that illustrates a unit pixel of an LCD device including the N type thin film transistor (n-TFT) and FIG. 2 is an equivalent circuit diagram that illustrates a unit pixel of an LCD device including the P type thin film transistor (p-TFT).

Referring to FIG. 1, the unit pixel includes an N type thin film transistor (n-TFT) (QN) formed on a region defined by two adjacent data lines DL1 and DL2 and two adjacent gate lines GL1 and GL2, a liquid crystal capacitor CLC and a storage capacitor CST commonly coupled to a drain electrode of the n-TFT (QN).

When a positive voltage is applied to the gate line, the n-TFT (QN) is turned on to provide a data signal transmitted from the data line to the liquid crystal capacitor CLC and the storage capacitor CST, thereby representing an image.

Referring to FIG. 2, the unit pixel includes a P type thin film transistor (p-TFT) (QP) formed on the region defined by two adjacent data lines DL1 and DL2 and two adjacent gate lines GL1 and GL2, the liquid crystal capacitor CLC and the storage capacitor CST coupled to a drain electrode of the p-TFT (QP).

When a negative voltage is applied to the gate line, the p-TFT (QP) is turned on to provide the data signal transmitted from the data line to the liquid crystal capacitor CLC and the storage capacitor CST, thereby representing the image.

Most of devices using an existing LTPS technique may correspond to a complementary metal oxide semiconductor (CMOS) device using both the n-TFT and p-TFT. An integrated circuit (IC) for the LTPS is typically adapted for CMOS characteristics. Gate signals and transmission gate signals used in the CMOS device are adapted for n-TFT characteristics and accordingly, gate turn-on voltages have positive polarities and gate turn-off voltages have negative polarities.

However, when a PMOS device (i.e., a device using only the p-TFT) is used, the gate turn-on voltage has a negative polarity and the gate turn-off voltage has a positive polarity, so that the gate signals and transmission gate signals must be inverted in order to use the integrated chip (IC) for the LTPS. Therefore, in the PMOS device, an inverter IC may be added to the IC for the LTPS to invert the signals.

When the PMOS device is initially operated, after the IC for the LTPS and the inverter IC are turned on, the IC for the LTPS does not generate a driving signal (e.g., gate signals and transmission gate signals) before image data is output. Namely, about 0V is output to the inverter IC. The inverter IC inverts the about 0V to provide the liquid crystal display panel with a particular voltage, such as about 3V. Therefore, the use of the inverter may give rise to a problem, such that an abnormal voltage level may be applied to the liquid crystal display panel before the input of the image data for representing a desired image. Thus, garbage data can be generated by the abnormal voltage to result in degraded display performance, such as a vertical line shown on a screen.

### SUMMARY

Accordingly, the present invention is provided to substantially obviate one or more problems due to limitations and disadvantages of the related art.

Exemplary embodiments of the present invention provide a display device including a data driver configured to provide an image signal. A scan driver generates a control signal corresponding to the image signal. An inverter inverts the control signal to provide the inverted control signal. A display panel comprising a PMOS transistor provides the image signal to a pixel electrode based on the inverted control signal. An interception unit intercepts an abnormal signal that is forwarded to the PMOS transistor.

In other exemplary embodiments of the present invention, the display device includes a data driver configured to provide an image signal. A scan driver generates a control signal corresponding to the image signal. An inverter inverts the control signal to provide the inverted control signal. A display panel comprising a PMOS transistor provides the image signal to a pixel electrode based on the inverted control signal. A power supply unit provides a power supply to activate the scan driver and inactivate the inverter at an early stage of operation, and provides the inverter with the power supply to activate the inverter after a predetermined period of time.

In still other exemplary embodiments of the present invention, the display device includes a data driver configured to provide an image signal. A scan driver generates a control signal corresponding to the image signal. An inverter inverts the control signal to provide the inverted control signal. A display panel comprising a PMOS transistor provides the image signal to a pixel electrode based on the inverted control signal. A signal filtering unit provides the inverted control signal outputted from the inverter to the display panel when the inverted control signal has a normal voltage level, and interrupts the inverted control signal when the inverted control signal has an abnormal voltage level.

Exemplary embodiments of the present invention also provides a method of driving a display device that includes a scan driver for generating a first scan signal having a first level, an inverter for inverting the first scan signal to generate a second scan signal having a second level and a display panel for displaying an image based on the second scan signal. In the method, the scan driver is activated and the inverter is inactivated at an early stage of operation. An activation of the scan driver is maintained and the inverter is activated after a predetermined period of time. An image signal is provided to the display panel based on an activation of the scan driver.

In other exemplary embodiments of the present invention, in the method of driving a display device that includes a scan driver for generating a first scan signal having a first level, an inverter for inverting the first scan signal to generate a second scan signal having a second level and a display panel for displaying an image based on the second scan signal. In the method, a voltage level of the second scan signal is identified at an early stage of operation. The second scan signal is provided to the display panel when the voltage level of the second scan signal is lower than or equal to a given voltage level, and the second scan signal is intercepted when the voltage level of the second scan signal is higher than the given voltage level. An image signal is provided to the display panel based on the second scan signal.

### BRIEF DESCRIPTION OF THE DRAWINGS

The present invention will become more apparent to those of ordinary skill in the art by describing, in detail, exemplary embodiments thereof with reference to the attached drawings, wherein like elements are represented by like reference numerals, which are given by way of illustration only and thus do not limit the exemplary embodiments of the present invention.

FIG. 1 is an equivalent circuit diagram that illustrates a unit pixel of an LCD device including an N type thin film transistor (n-TFT).

FIG. 2 is an equivalent circuit diagram that illustrates a unit pixel of an LCD device including a P type thin film transistor (p-TFT).

FIG. 3 is a block diagram that illustrates a liquid crystal display device according to an exemplary embodiment of the present invention.

FIGS. 4A through 4C are waveform diagrams that illustrate transmission gate signals in FIG. 3, and FIGS. 4D through 4F are waveform diagrams illustrating gate signals in FIG. 3.

FIGS. 5A through 5C are waveform diagrams that illustrate inverted transmission gate signals in FIG. 3, and FIGS. 5D through 5F are waveform diagrams illustrating inverted gate signals in FIG. 3.

FIG. 6 is an equivalent circuit diagram that illustrates a division unit and a display unit in FIG. 3.

FIG. 7 is a block diagram that illustrates a liquid crystal display device according to another exemplary embodiment of the present invention.

FIG. 8 is a block diagram that illustrates a signal filtering unit in FIG. 7 according to an exemplary embodiment of the present invention.

FIG. 9 is a block diagram that illustrates a signal filtering unit in FIG. 7 according to another exemplary embodiment of the present invention.

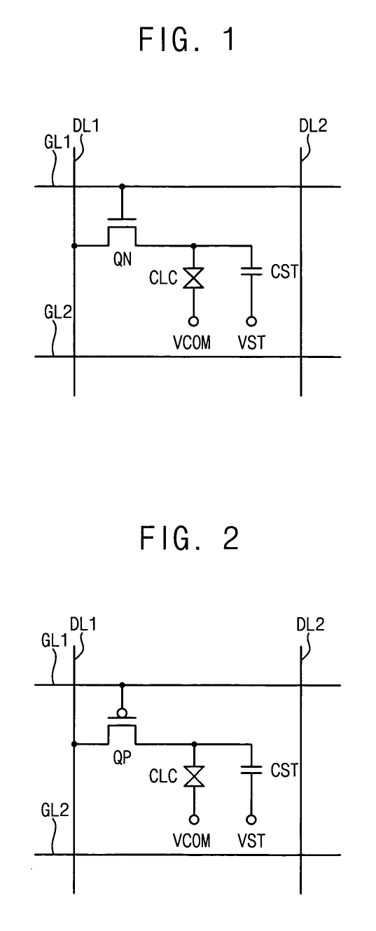

### DESCRIPTION OF THE EXEMPLARY EMBODIMENTS

Hereinafter, the present invention will be explained in detail with reference to the accompanying drawings.

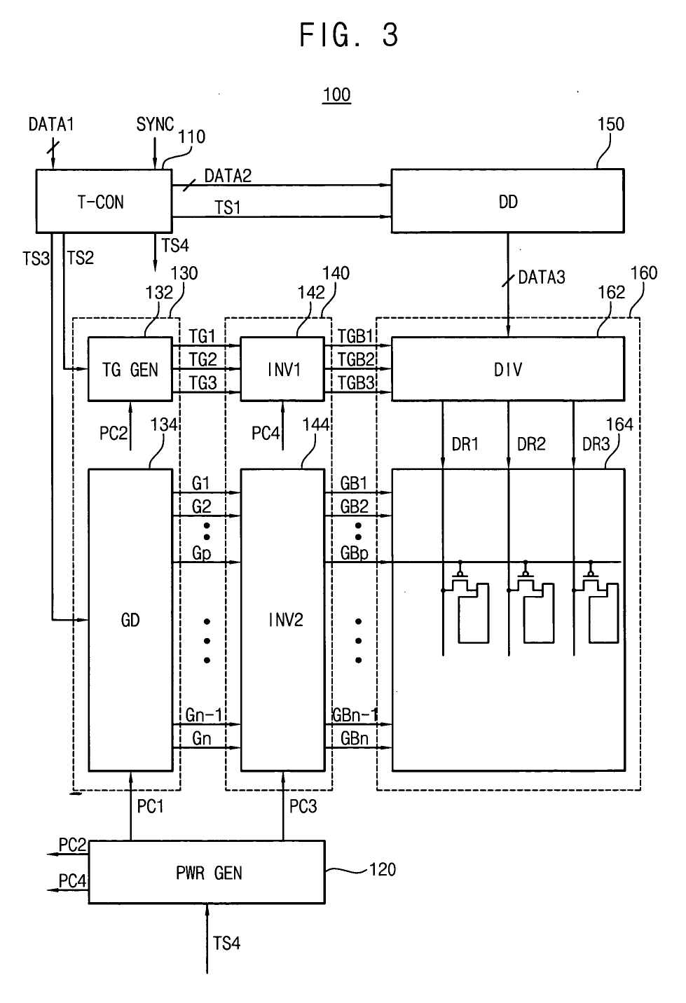

FIG. 3 is a block diagram illustrating a liquid crystal display device according to an exemplary embodiment of the present invention.

Referring to FIG. 3, the liquid crystal display device 100 includes a timing controller 110, a power generator 120, a scan driver 130, an inverter unit 140, a data driver 150, and a display panel 160.

The timing controller 110 receives a first data signal DATA1 and a synchronization signal SYNC from a host system, such as a graphic controller, and provides a second data signal DATA2 and a first control signal TS1 to the data driver 150. Additionally, the timing controller 110 provides the scan driver 130 with second and third control signals TS2 and TS3, and provides the power generator 120 with a fourth control signal TS4.

The power generator 120 provides first and second power PC1 and PC2 to the scan driver 130 and provides third and fourth power PC3 and PC4 to the inverter unit 140.

In particular, the power generator 120 provides the first, second, third, and fourth power voltages PC1, PC2, PC3, and PC4, such that the scan driver 130 is activated and the inverter unit 140 is inactivated at an initial stage. The inverter unit 140 is activated a predetermined time period after the initial stage. For example, for the inverter unit 140 is activated when the data driver 150 starts to provide the display panel 160 with a plurality of data voltages DATA3 based on the second data signal DATA2, the first control signal TS1 transmitted from the timing controller 110, and gamma reference voltages (not shown). Namely, the inverter unit 140 is powered on when the data voltages DATA3 are outputted after powering on scan driver 130. Therefore, the generation of abnormal voltage levels at an early stage of operation may be prevented. Although not shown in FIG. 3, the power generator 120 also provides power to the data driver 150 and the display panel 160.

The scan driver 130 includes a transmission gate signal generation unit 132 and a gate driver 134.

In particular, the transmission gate signal generation unit 132 provides first, second, and third transmission gate signals TG1, TG2, and TG3 to the inverter unit 140 in sequence.

The gate driver 134 provides a plurality of gate signals G1, G2, . . . Gp, . . . , Gn-1, and Gn to the inverter unit 140.

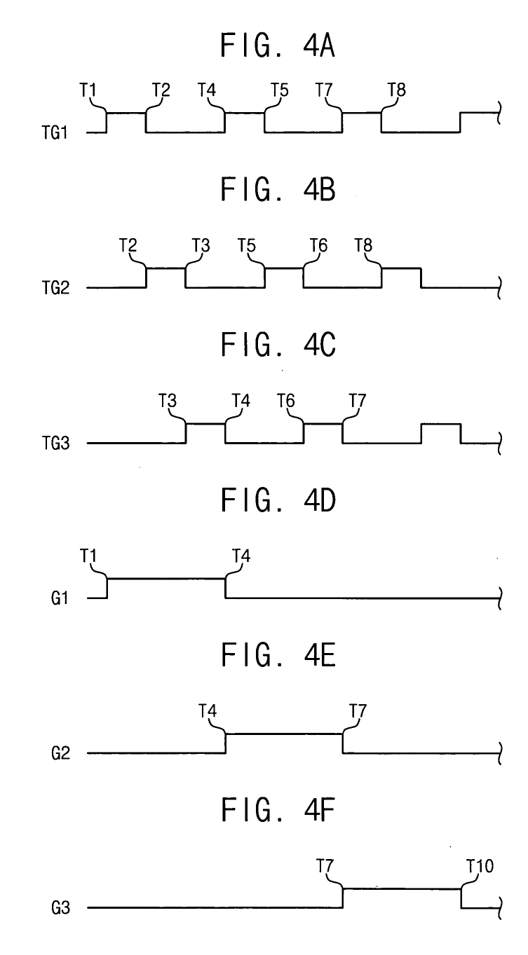

FIGS. 4A through 4C are waveform diagrams illustrating the transmission gate signals TG1, TG2, and TG3 in FIG. 3 and FIGS. 4D through 4F are waveform diagrams illustrating gate signals G1, G2, and G3 in FIG. 3.

Referring to FIGS. 4A through 4C, the first transmission gate signal TG1 rises at a first time T1 and falls at a second time T2. The second transmission gate signal TG2 rises at the second time T2 and falls at a third time T3. The third transmission gate signal TG3 rises at the third time T3 and falls at a fourth time T4. When the third transmission gate signal TG3 falls, the rising transition of the first transmission gate signal TG1 is repeatedly performed.

Referring to FIGS. 4D through 4F, the first gate signal G1 rises at the first time T1 and falls at the fourth time T4. The second gate signal G2 rises at the fourth time T4 and falls at a seventh time T7. The third gate signal G3 rises at the seventh time T7 and falls at a tenth time T10.

Thus, during the falling and rising transition of each inverted gate signal, the inverted transmission gate signals fall and rise in sequence.

Referring now to FIG. 3, the inverter unit 140 includes a first inverter (INV1) 142 and a second inverter (INV2) 144.

The first inverter 142 inverts the transmission gate signals TG1, TG2, and TG3 and provides the inverted transmission gate signals TGB1, TGB2, and TGB3 to the display panel 160.

The second inverter 144 inverts the gate signals G1, G2, . . . Gp, . . . , Gn-1, and Gn and provides the inverted gate signals GB1, GB2, . . . , GBp, . . . , GBn-1, and GBn to the display panel 160.

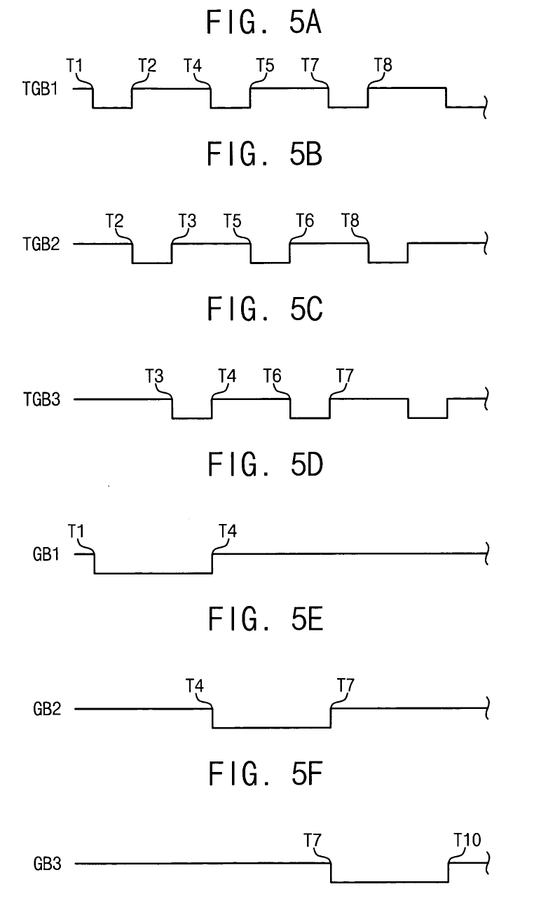

FIGS. 5A through 5C are waveform diagrams illustrating the inverted transmission gate signals TGB1, TGB2, and TGB3 in FIG. 3 and FIGS. 5D through 5F are waveform diagrams illustrating the inverted gate signals GB1, GB2, and GB3 in FIG. 3.

Referring to FIGS. 5A through 5C, the first inverted transmission gate signal TGB1 falls at a first time T1 and rises at a second time T2. The second inverted transmission gate signal TGB2 falls at the second time T2 and rises at a third time T3. The third inverted transmission gate signal TGB3 falls at the third time T3 and rises at a fourth time T4. When the third inverted transmission gate signal TGB3 rises, a falling transition of the first inverted transmission gate signal TGB1 is repeatedly performed.

Referring to FIGS. 5D through 5F, the first inverted gate signal GB1 falls at the first time T1 and rises at the fourth time T4. The second inverted gate signal GB2 falls at the fourth time T4 and rises at a seventh time T7. The third inverted gate signal GB3 falls at the seventh time T7 and rises at a tenth time T10.

Thus, during the falling and rising transition of each inverted gate signal, the inverted transmission gate signals fall and rise in sequence.

The data driver 150 provides a plurality of data voltages DATA3 to the display panel 160 based on the second data signal DATA2, the first control signal TS1 from the timing controller 110, and the gamma reference voltages (not shown).

The data driver 150, for example, may include a printed circuit board (PCB), a flexible printed circuit board (FPCB) coupled to the PCB, and one or more data driver chips mounted on the FPCB. Alternatively, the data driver 150 may be integrated on a peripheral area of the display panel 160.

The display panel 160 includes a division unit 162 and a display unit 164 to display an image based on the inverted transmission gate signals TGB1, TGB2, and TGB3, the inverted gate signals GB1, GB2, . . . GBp, . . . , GBn-1, and GBn and the plurality of data voltages DATA3.

In particular, the division unit 162 determines output paths for the respective data voltages DATA3 provided from the data driver 150 to the display unit 164 using the inverted transmission gate signals TGB1, TGB2, and TGB3.

The display unit 164 may include a plurality of switching elements arranged in a matrix shape and a pixel electrode electronically coupled to the switching elements, respectively. Each of the switching elements includes a PMOS transistor that is turned on in response to a negative voltage and turned off in response to a positive voltage.

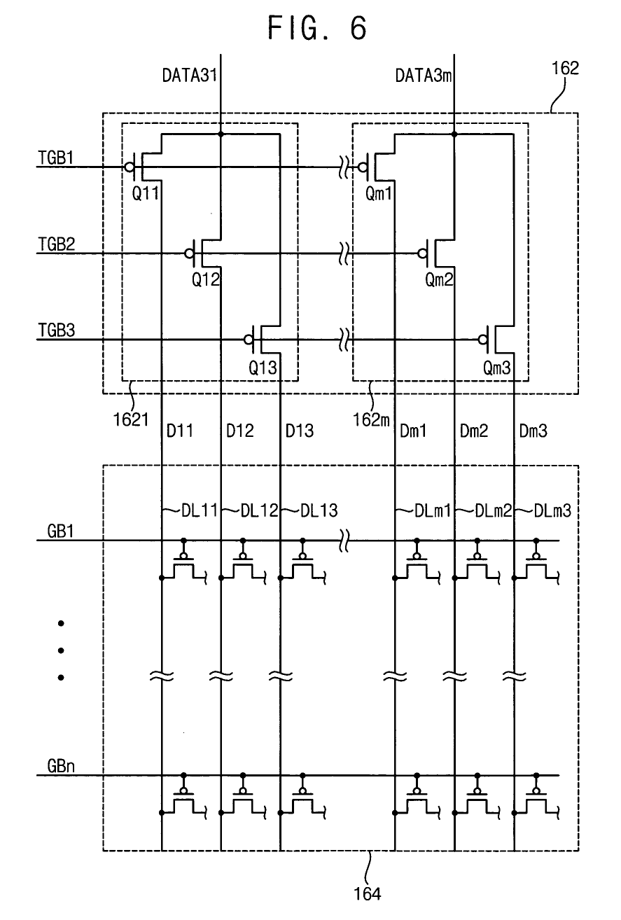

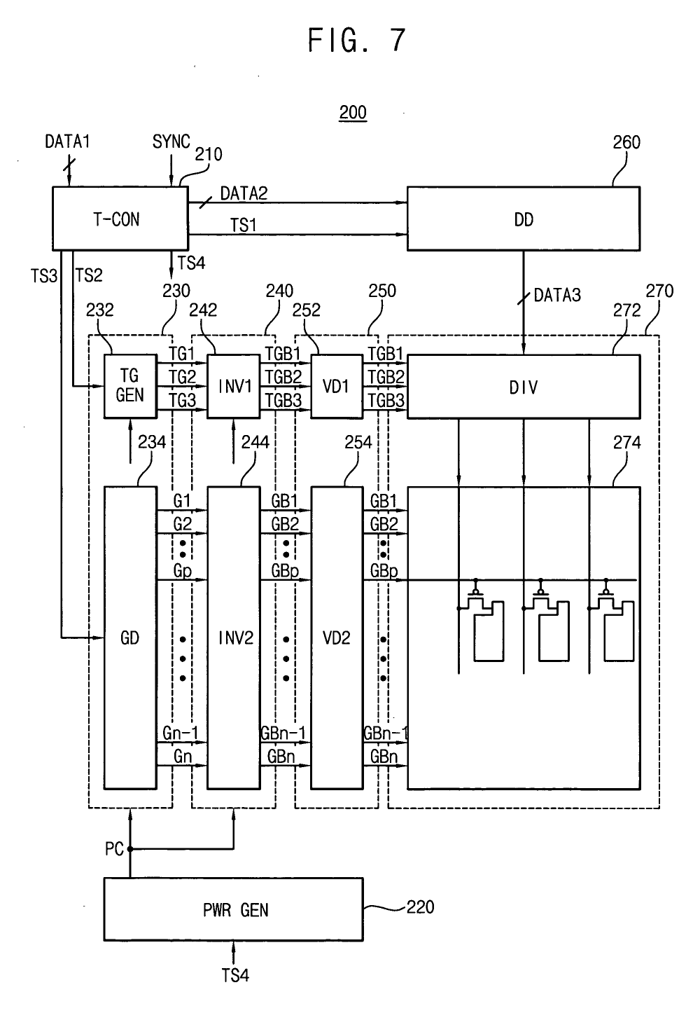

Examples of the division unit 162 and the display unit 164 shown in FIG. 6 are described in more detail below.

FIG. 6 is an equivalent circuit diagram illustrating the division unit 162 and the display unit 164 in FIG. 3.

Referring to FIG. 6, the division unit 162 includes a plurality of sub division units 1621 through 162m to selectively output data signals DATA31 through DATA3m provided from the data driver 150 to separate output paths, based on the inverted transmission gate signals TGB1, TGB2, and TGB3. Each of the respective data signals DATA31 through DATA3m are data signal groups having a plurality of data voltages for sub pixels in each pixel. The data signals DATA31 through DATA3m are provided to the display unit 164 to display an image.

Each of the sub division units 1621 through 162m may include, for example, one input terminal and three output terminals to function as a DEMUX.

The sub division unit 1621 includes first, second, and third PMOS transistors Q11, Q12, and Q13 whose source electrodes are commonly coupled to receive a first data signal group DATA31. The first through third PMOS transistors Q11, Q12, and Q13 have gate electrodes that receive the first through third inverted transmission gate signals TGB1, TGB2, and TGB3, respectively, and drain electrodes coupled to first through third data lines DL11, DL12, and DL13, respectively.

In operation, the first PMOS transistor Q11 is turned on or turned off based on a status of the first inverted transmission gate signal TGB1. The first PMOS transistor Q11 provides a data signal selected from the first data signal group DATA31, which is applied to the source electrode of the first PMOS transistor Q11, to the display unit 164 through the first data line DL11.

The second PMOS transistor Q12 is turned on or off based on a status of the second inverted transmission gate signal TGB2. The second PMOS transistor Q12 provides a data signal selected from the first data signal group DATA31, which is applied to the source electrode of the second PMOS transistor Q12, to the display unit 164 through the second data line DL12.

The third PMOS transistor Q13 is turned on or off based on a status of the third inverted transmission gate signal TGB3. The third PMOS transistor Q13 provides the display unit 164 with a data signal selected from the first data signal group DATA31, which is applied to the source electrode of the third PMOS transistor Q13, through the third data line DL13.

Similarly, the m-th sub division unit 162m includes first, second, and third PMOS transistors Qm1, Qm2, and Qm3 whose source electrodes are commonly coupled to receive an m-th data signal group DATA3m. The first through third PMOS transistors Qm1, Qm2, and Qm3 have gate electrodes that receive the first through third inverted transmission gate signals TGB1, TGB2, and TGB3, respectively, and drain electrodes coupled to a first through third data lines DLm1, DLm2, and DLm3, respectively.

In operation, the first PMOS transistor Qm1 is turned on or off based on a status of the first inverted transmission gate signal TGB1. The first PMOS transistor Qm1 provides the display unit 164 with a data signal selected from the m-th data signal group DATA3m, which is applied to the source electrode of the first PMOS transistor Qm1, through the first data line DLm1.

The second PMOS transistor Qm2 is turned on or off based on a status of the second inverted transmission gate signal TGB2. The second PMOS transistor Qm2 provides the display unit 164 with a data signal selected from the m-th data signal group DATA3m, which is applied to the source electrode of the second PMOS transistor Qm2, through the second data line DLm2.

The third PMOS transistor Qm3 is turned on or off based on a status of the third inverted transmission gate signal TGB3. The third PMOS transistor Qm3 provides the display unit 164 with a data signal selected from the m-th data signal group DATA3m, which is applied to the source electrode of the third PMOS transistor Qm3, through the third data line DLm3.

The display unit 164 includes 3×m data lines, n gate lines, a plurality of PMOS transistors, and a plurality of pixel electrodes that are electronically coupled to the PMOS transistors, respectively.

The PMOS transistors and the pixel electrodes coupled to the PMOS transistors of the display unit 164 are similar in form and function to analogous elements already described with reference to FIG. 2.

FIG. 3 shows the voltage generator 120 configured to control separate power supplies (i.e., the first through fourth power PC1˜PC4) for the transmission gate generator 132, the gate driver 134, and the first and second inverters 142 and 144, respectively. However, it is well known to those skilled in the art that separate power supplies for only the transmission gate generator 132 and the first inverter 142 may also achieve the purpose of the exemplary embodiments of the present invention as well.

According to an exemplary embodiment as described above, the inverter may be disposed at an output terminal of a driver IC for the PMOS device. In addition, power supplies for the inverter and the driver IC may be separately controlled to assure that an abnormal voltage level is not provided to a liquid crystal display panel where the PMOS transistors are integrated. Therefore, display defects may be prevented.

FIG. 7 is a block diagram illustrating a liquid crystal display device according to another exemplary embodiment of the present invention.

Referring to FIG. 7, the liquid crystal display device 100 includes a timing controller 210, a power generator 220, a scan driver 230, an inverter unit 240, a signal filtering unit 250, a data driver 260, and a display panel 270.

The timing controller 210 receives the first data signal DATA1 and the synchronization signal SYNC from the host system, such as the graphic controller, and provides the data driver 260 with the second data signal DATA2 and the first control signal TS1. Additionally, the timing controller 210 provides the scan driver 230 with the second and third control signals TS2 and TS3 and provides the power generator 220 with the fourth control signal TS4.

The power generator 220 provides power (PC) to the scan driver 230 and the inverter unit 240 in response to the fourth control signal TS4. Although not shown in FIG. 7, the power generator 220 also provides power to the signal filtering unit 250, the data driver 260 and the display panel 270.

The scan driver 230 includes a transmission gate signal generation unit 232 and a gate driver 234. The transmission gate signal unit 232 provides the first, second, and third transmission gate signals TG1, TG2, and TG3 (similar to the signals shown in FIGS. 4A to 4C) to the inverter unit 240. The gate driver 234 provides the plurality of gate signals G1, G2, . . . Gp, . . . , Gn-1, and Gn (similar to those shown in FIGS. 4D to 4F) to the inverter unit 240.

The inverter unit 240 includes a first inverter 242 and a second inverter 244. The first inverter 242 inverts the transmission gate signals TG1, TG2, and TG3 and provides the signal filtering unit 250 with the inverted transmission gate signals TGB1, TGB2, and TGB3 (similar to those shown in FIGS. 5A through 5C).

The second inverter 244 inverts the gate signals G1, G2, . . . Gp, . . . , Gn-1, and Gn and provides the signal filtering unit 250 with the inverted gate signals GB1, GB2, . . . , GBp, . . . , GBn-1, and GBn (similar to those shown in FIGS. 5D through 5F).

The signal filtering unit 250 includes a first filtering unit 252 and a second filtering unit 254.

The first filtering unit 252 provides the display panel 270 with the inverted transmission gate signals TGB1, TGB2, and TGB3 transmitted from the first inverter 242, when the inverted transmission gate signals TGB1, TGB2, and TGB3 have normal voltage levels. When the inverted transmission gate signals TGB1, TGB2, and TGB3 have abnormal voltage levels, the first filtering unit 252 does not allow transmission of the inverted transmission gate signals TGB1, TGB2, and TGB3. For example, the first filtering unit 252 may be configured to prevent transmission of an inverted transmission gate signal having a voltage level that is above a threshold voltage level of the PMOS transistor.

The second filtering unit 254 provides the display panel 270 with the inverted gate signals GB1, GB2, . . . GBp, . . . , GBn-1, and GBn transmitted from the second inverter 244 when the inverted gate signals GB1, GB2, . . . GBp, . . . , GBn-1, and GBn have normal voltage levels. When the inverted gate signals GB1, GB2, . . . GBp, . . . , GBn-1 and GBn have abnormal voltage levels, the second filtering unit 254 does not allow transmission of the inverted gate signals GB1, GB2, . . . GBp, . . . , GBn-1 and GBn. As above mentioned with regard to the related art, the inverted transmission gate signals TGB1, TGB2, and TGB3 and the inverted gate signals GB1, GB2, . . . , GBn-1, and GBn may have abnormal voltage levels in case where the inverter IC may invert about 0V inputted thereto before the image data is outputted to a particular voltage, such as about 3V.

The data driver 260 provides the display panel 270 with a plurality of data voltages DATA3 based on the second data signal DATA2, the first control signal TS1, and the gamma reference voltages.

The display panel 270 includes a division unit 272 and a display unit 274 to display an image based on the inverted transmission gate signals TGB1, TGB2, and TGB3, the inverted gate signals GB1, GB2, . . . GBp, . . . , GBn-1, and GBn, and the plurality of data voltages DATA3.

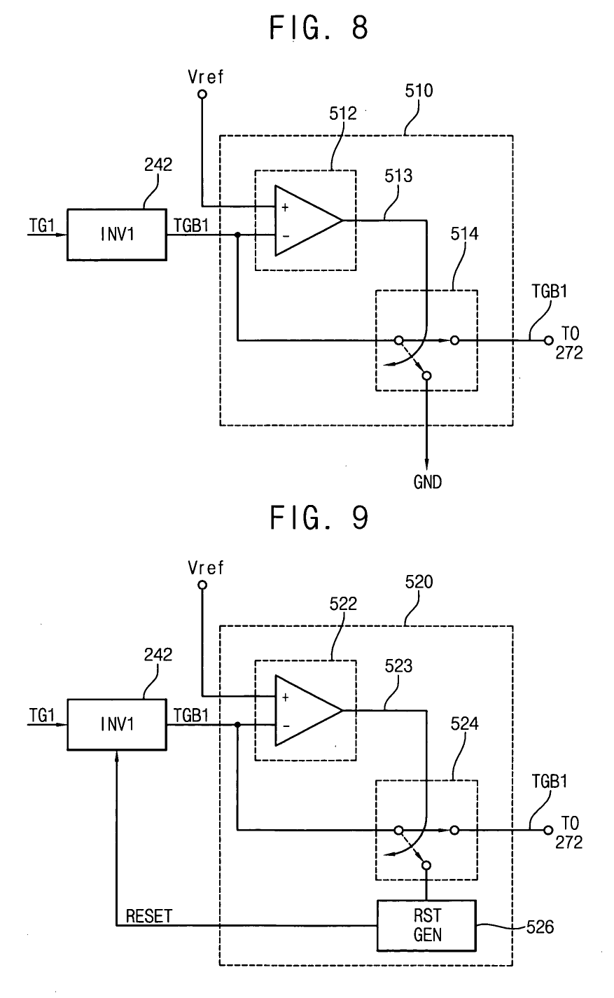

FIG. 8 is a block diagram illustrating the signal filtering unit in FIG. 7 according to an exemplary embodiment of the present invention. In particular, FIG. 8 illustrates the first filtering unit 510 for selectively coupling an input signal to ground when the input signal has a voltage level below a threshold voltage.

Referring to FIG. 8, the first filtering unit 510 includes a comparator 512 and a switch unit 514.

The comparator 512 compares the inverted transmission gate signals TGB1 input through a first input terminal with a reference voltage Vref input through a second input terminal to output a comparison signal 513 to the switch unit 514.

The switch unit 514 is operated based on the comparison signal 513 to provide the inverted transmission gate signal TGB1 to either the division unit 272 or the ground.

Generally, the inverted transmission gate signal TGB1 may have a normal state when the inverted transmission gate signal TGB1 has a voltage level greater than a predetermined threshold voltage and the inverted transmission gate signal TGB1 may have an abnormal state when the inverted transmission gate signal TGB1 has a voltage level lower than the predetermined threshold voltage. Accordingly, the threshold voltage may be designated as the reference voltage.

Therefore, when the inverted transmission gate signal TGB1 has a voltage level higher than the reference voltage Vref, the switch unit 514 is operative to output the inverted transmission gate signal TGB1 to the division unit 272. When the inverted transmission gate signal TGB1 has a voltage level lower than the reference voltage Vref, the switch unit 514 is operative to couple the inverted transmission gate signal TGB1 to the ground.

FIG. 9 is a block diagram illustrating the signal filtering unit in FIG. 7 according to another exemplary embodiment of the present invention. In particular, FIG. 9 illustrates the first filtering unit 520 that outputs a reset signal RESET when the input signal has a voltage level lower than the threshold voltage.

Referring to FIG. 9, the first filtering unit 520 includes a comparator 522, a switch unit 524, and a reset signal generator 526.

The comparator 522 compares the inverted transmission gate signals TGB1 input through a first input terminal with the reference voltage Vref input through a second input terminal to output a comparison signal 523 to the switch unit 524.

The switch unit 524 is operated based on the comparison signal 523 to provide the inverted transmission gate signal TGB1 to the division unit 272 or the reset signal generator 526.

The reset signal generator 526 is operative based on the inverted transmission gate signal TGB1 to provide the reset signal RESET to the first inverter 242. The first inverter 242 is reset based on the reset signal RESET.

It is noted that even though the first filtering unit 510 or 520 in FIGS. 8 and 9 is described with reference to the first filtering unit 252 in FIG. 7, the first filtering unit 510 or 520 may also be implemented in the second filtering unit 254 in FIG. 7.

In FIG. 7, the signal filtering unit 250 includes the first and second filtering units 252 and 254 to detect whether the inverted transmission gate signal output from the first inverter 242 or the inverted gate signal output from the second inverter 244 has an abnormal voltage level, respectively. Alternatively, the signal filtering unit 250 may use only the first filtering unit 252 to detect whether the inverted transmission gate signal output from the first inverter 242 has an abnormal voltage level.

According to exemplary embodiments of the present invention, an inverter may be disposed on an output terminal of a driver integrated chip (IC) for the PMOS driver of a display device, and a circuit or element may be added to the display device to couple a driving signal to the ground or reset the inverter when an abnormal voltage level is generated at an early stage of operation.

Therefore, the abnormal voltage signal may not be provided to the liquid crystal display panel where the PMOS transistors are integrated, to prevent the generation of the garbage data resulting from the abnormal voltage level.

As described above, in the display device including the PMOS device, separate power supplies for the driver IC and the inverter may be controlled to assure that an abnormal voltage level is not generated at the early stage of operation.

In addition, a circuit or element for intercepting an abnormal voltage at the inverter may be alternatively added to the display device so as to prevent the transmission of abnormal voltage levels to the display panel, thereby avoiding the display defects.

Having thus described exemplary embodiments of the present invention, it is to be understood that the invention defined by the appended claims is not to be limited by particular details set forth in the above description as many apparent variations thereof are possible without departing from the spirit or scope thereof as hereinafter claimed.

What is claimed is:

1. A display device comprising:
a data driver configured to provide an image signal;
a scan driver configured to generate a control signal corresponding to the image signal;
an inverter configured to invert the control signal to provide an inverted control signal;
a display panel comprising a PMOS transistor configured to provide the image signal to a pixel electrode based on the inverted control signal; and
an interception unit configured to intercept an abnormal signal that is forwarded to the PMOS transistor.

2. The display device of claim 1, wherein the interception unit provides a power supply to activate the scan driver and inactivate the inverter for an initial period of operation of the display device.

3. The display device of claim 1, wherein the abnormal signal corresponds to the inverted control signal having an abnormal voltage level.

4. The display device of claim 1, wherein the abnormal signal comprises a voltage level higher than a threshold voltage of the PMOS transistor.

5. A display device comprising:
a data driver configured to provide an image signal;
a scan driver configured to generate a control signal corresponding to the image signal;
an inverter configured to invert the control signal to provide an inverted control signal;
a display panel comprising a PMOS transistor configured to provide the image signal to a pixel electrode based on the inverted control signal; and
a power supply unit configured to activate the scan driver and inactivate the inverter at an early stage of operation, and configured to activate the inverter after a predetermined period of time.

6. The display device of claim 5, wherein the PMOS transistor is formed on a display unit of the display panel and the pixel electrode is electronically coupled to the PMOS transistor.

7. The display device of claim 6, wherein the scan driver includes a gate driver for outputting a first scan signal to activate the PMOS transistor formed on the display unit.

8. The display device of claim 7, wherein the inverter is coupled to an output terminal of the gate driver to provide the first scan signal having an inverted polarity to the PMOS transistor formed on the display unit.

9. The display device of claim 5, wherein the display panel comprises a division unit including a PMOS transistor configured to output the image signals to output paths different from one another.

10. The display device of claim 9, wherein the scan driver includes a transmission gate driver for providing a second scan signal to activate the PMOS transistor formed on the division unit.

11. The display device of claim 10, wherein the inverter is coupled to an output terminal of the transmission gate driver to provide the second scan signal having an inverted polarity to the PMOS transistor formed on the division unit.

12. The display device of claim 5, wherein the predetermined period of time corresponds to a time interval required for the data driver to start outputting the image signal from the early stage of operation.

13. A display device comprising:
a data driver configured to provide an image signal;
a scan driver configured to generate a control signal corresponding to the image signal;
an inverter configured to invert the control signal to provide an inverted control signal;
a display panel comprising a PMOS transistor for providing the image signal to a pixel electrode based on the inverted control signal; and
a signal filtering unit configured to provide the inverted control signal outputted from the inverter to the display panel when the inverted control signal has a normal voltage level and configured to interrupt the inverted control signal when the inverted control signal has an abnormal voltage level.

14. The display device of claim 13, wherein the abnormal voltage level of the inverted control signal is higher than a threshold voltage of the PMOS transistor.

15. The display device of claim 13, wherein the signal filtering unit provides a reset signal to the inverter to reset the inverter when the inverted control signal has the abnormal voltage level.

16. The display device of claim 13, wherein the signal filtering unit couples the inverted control signal to a ground when the inverted control signal has the abnormal voltage level.

17. The display device of claim 13, wherein the PMOS transistor is formed on a display unit of the display panel and the pixel electrode is electronically coupled to the PMOS transistor.

18. The display device of claim 17, wherein the scan driver includes a gate driver for providing a first scan signal to activate the PMOS transistor formed on the display unit.

19. The display device of claim 18, wherein the inverter is coupled to an output terminal of the gate driver to provide the first scan signal having an inverted polarity to the PMOS transistor formed on the display unit.

20. The display device of claim 13, wherein the display panel includes a division unit including a PMOS transistor configured to output the image signals to output paths different from one another.

21. The display device of claim 20, wherein the scan driver includes a transmission gate driver for providing a second scan signal to activate the PMOS transistor formed on the division unit.

22. The display device of claim 21, wherein the inverter is coupled to an output terminal of the transmission gate driver to provide the second scan signal having an inverted polarity to the PMOS transistor formed on the division unit.

23. A method of driving a display device including a scan driver for generating a first scan signal having a first level, an inverter for inverting the first scan signal to generate a second scan signal having a second level, and a display panel for displaying an image based on the second scan signal, the method comprising:
activating the scan driver and inactivating the inverter at an early stage of operation;
maintaining an activation of the scan driver and activating the inverter after a predetermined period of time; and
providing an image signal to the display panel based on an activation of the scan driver.

24. A method of driving a display device including a scan driver for generating a first scan signal having a first level, an inverter for inverting the first scan signal to generate a second scan signal having a second level, and a display panel for displaying an image based on the second scan signal, the method comprising:
identifying a voltage level of the second scan signal at an early stage of operation;
providing the second scan signal to the display panel when the voltage level of the second scan signal is lower than or equal to a given voltage level and intercepting the second scan signal when the voltage level of the second scan signal is higher than the given voltage level; and
providing an image signal to the display panel based on the second scan signal.
